(19) United States
(12) Patent Application Publication
(10) Pub. No.: US 2023/0026262 A1
(43) Pub. Date: Jan. 26, 2023

(54) Wireless Channel Selection for Multipath Authentication of a User

(71) Applicant: TruU, Inc., Palo Alto, CA (US)

(72) Inventors: Lucas Allen Budman, Denver, CO (US); David Brett Pasirstein, Denver, CO (US)

(21) Appl. No.: 17/870,594

(22) Filed: Jul. 21, 2022

Related U.S. Application Data
(60) Provisional application No. 63/223,973, filed on Jul. 21, 2021.

(51) Int. Cl. G06F 21/34

(52) U.S. Cl. CPC G06F 21/34

(57) ABSTRACT

An identity verification system determines a communication channel that transmits signals between the computer system and an authentication device by selecting a data link circuit at the computer system. The identity verification system transmits an authentication request received at the computer system to the authentication device via the communication channel and the authentication device validates the authentication request. In response to the authentication device validating the authentication request, the identity verification system measures a proximity of the authentication device to the computer system based on data transmitted through a proximity channel. If the measured proximity of the authentication device satisfies a threshold proximity, the user verification system grants grant the target user access to the to the computer system.

### CROSS REFERENCE TO RELATED APPLICATIONS

This application claims the benefit of U.S. Provisional Pat. Application No. 63/223,973, filed on Jul. 21, 2021, which is incorporated by reference herein in its entirety for all purposes.

### TECHNICAL FIELD

This disclosure relates generally to techniques for user identification and, more specifically, to techniques for authenticating a user requesting access to a secured asset by selecting a wireless channel.

### BACKGROUND

Conventional techniques for authorizing a user to access a computer system require the user to either enter credentials (e.g., a login name and corresponding password) to authenticate their identity as an authorized user of the computer system or present biometric evidence of their identity (e.g., a fingerprint scan). Alternatively, a user may authenticate their identity by offering physical authentication objects that plugs into the computer system, for example a smart card or a universal serial bus (USB) security device. However, these conventional techniques offer inadequate protection against unauthorized access to computers and data systems. Credentials and fingerprints may be forged. Physical authentication objects are often stored with the computer to which they are intended to grant access, so when a thief steals the computer they would likely also be able to steal the authentication object.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. (Figure) 1 shows a user identification system 100 for authenticating a target user requesting access to a secured asset, according to one embodiment.

FIG. 2 is an interaction diagram for communicating data between a secured asset and an authentication device to validate an authentication request, according to one embodiment.

FIG. 3 is a block diagram of an example system architecture of an emulation module, according to one embodiment.

FIG. 4 illustrates an example process for verifying an authentication request from the perspective of the emulation module of the secured asset, according to one embodiment.

FIG. 5 illustrates an example process for verifying an authentication request from the perspective of an emulation application of the authentication request, according to one embodiment.

FIG. 6 illustrates an example process for determining a communication channel at the emulation module, according to one embodiment.

FIG. 7 illustrates an example process for determining a proximity channel at the emulation module, according to one embodiment.

FIG. 8 is a block diagram illustrating components of an example machine able to read instructions from a machine-readable medium and execute them in a processor (or controller), according to one embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Overview

Embodiments of a user identification system authenticate a target user’s request for access to a secured asset, for example a computer system, a networked data system resource, or a combination thereof. Embodiments of the present disclosure provide various devices, methods, and techniques for selecting a communications channel, a proximity channel, or both based on the availability of data link circuits and conditions impacting the reliability of communications transmitted by the available data link circuits.

In embodiments where the secured asset is a computer system, the user identification system authenticates the target user’s request by interrogating a software device driver executing on the computer system. In such embodiments, the software device driver presents itself to an operating system of computer as a software driver for a physically attached security circuit (e.g., a smart card, a universal serial bus (USB) security device). Accordingly, rather than communicating with the physically attached security circuit, the software device driver communicates with an authentication device separate from the secured asset (e.g., a mobile device). The authentication device stores and generates authentication credentials and/or other data necessary to authenticate the target user’s request for access. The computer system communicates with the authentication device via a communications channel between the computer system and the authentication device. Accordingly, the computer system may use the communications channel to authenticate a target user in possession of an authentication device configured with authentication credentials, certificates, and/or other data for authenticating the user. The identity verification system may additionally verify the identity of a requesting target user based on whether the proximity of the target user to the authentication device satisfies authorization policies for accessing the secured asset.

### System Environment Example

.FIG. (Figure) 1 shows a user identification system 100 for authenticating a target user requesting access to a secured asset, according to one embodiment. The user identification system 100 may include an authentication device 115, a secured asset 110, an identity verification system 130, and a network 140. Although FIG. 1 illustrates only a signal instance of the components of the user identification system 100, more than one of each component may be present in practice and additional or fewer components may be used.

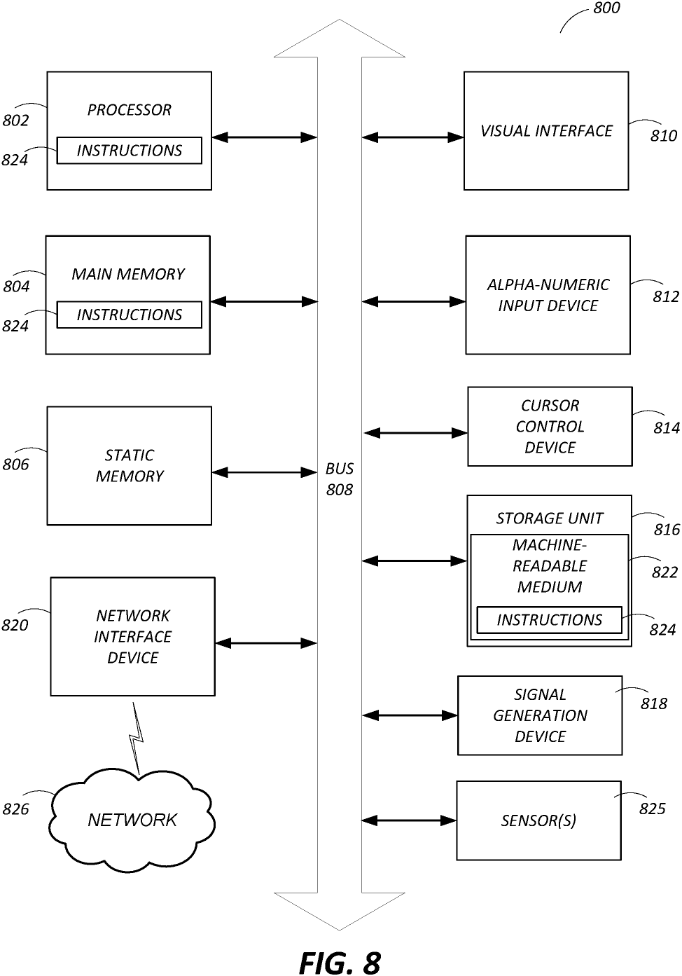

A secured asset 110 may be an object or an environment to which a target user is attempting to gain access. To gain access to the secured asset 110, the target user authenticates their identity using one or more of the techniques described herein. For example, a secured asset 110 may be a physical object in a secured environment, a computer system, a networked data system resource, or a combination of the two. The secured asset 110 may include one or more data link circuits 111 capable of transmitting digital data. Although only one data link circuit 111 is illustrated in FIG. 1, a person having ordinary skill in the art would appreciate that in practice the secured asset 110 may have multiple data link circuits of varying types. As discussed herein, the data link circuit 111 may be wired, wireless, optical, acoustic, or a combination thereof. Wireless data link circuits 111 implement any wireless communication technique that is both feasible and/or compliant with industry standards including, but not limited to, Bluetooth, WiFi, long term evolution (LTE), etc. Wired data link circuits 111 may implement any wired communication technique that is both feasible and/or complaint with industry standards including, but not limited to, Ethernet suite of standards. The system architecture of a secured asset 110 that is a computer system is further illustrated in FIG. 8.

The secured asset 110 communicates with an authentication device 115 via a communication channel 120. The authentication device 115 is a computing device that generates authentication credentials and/or other data necessary to authenticate a user’s request for access. Accordingly, the authentication device 115 may interact with the secured asset 110 via the network 140. The authentication device 115 may be a mobile device carried by a target user, for example a smartphone, a tablet computer, a smartwatch, a personal digital assistant. For simplicity, the authentication device 115 is described herein as a mobile device (e.g., a cellular phone or a smartphone). A person having ordinary skill in the art, however, would recognize that authentication device 115 may also be any other type of computing device capable of executing one or more of the processing configurations described herein.

For simplicity, the secured asset 110 is described herein as a computer system. However, a person having ordinary skill in the art would recognize that the secured asset 110 may also include any other type of asset and the techniques described herein may be applied to any other suitable asset.

The authentication device 115 comprises data link circuits 117 and an emulation application 125. The data link circuits 117 of the authentication device 115 are functionally and structurally consistent with the description provided herein of the data link circuits 111 of the secured asset 110. The data link circuits 117 transmit digital data. Although only one data link circuit 117 is illustrated in FIG. 1, a person having ordinary skill in the art would appreciate that in practice the secured asset 110 will have multiple data link circuits of varying types. As discussed herein, the data link circuit 111 may be wired, wireless, optical, acoustic, or a combination thereof. Wireless data link circuits 117 implement any wireless communication technique that is both feasible and/or compliant with industry standards, for example, Bluetooth, WiFi, LTE, nG (n being an integer) wireless communications. Wired data link circuits 117 may implement any wired communication technique that is both feasible and/or complaint with industry standards including, but not limited to, Ethernet suite of standards. The system architecture of an authentication device 115 is further illustrated in FIG. 8.

The emulation application 125 is an application stored and executing within the authentication device 115 to provide authentication based on data stored within the authentication device 115. The emulation application 125 is further described with relative to the emulation module 135 of the identity verification system 130.

In some embodiments, the authentication device 115 comprises one or more sensors (not shown) that are configured to collect motion data (direct and indirect) describing the movements of a user operating the authentication device 115. As described herein, the one or more sensors may include a range of sensors or data sources, either individually or in combination, for collecting direct motion data (e.g., accelerometers, gyroscopes, GPS coordinates, etc.) or indirect motion data (e.g., Wi-Fi data, compass data, magnetometer data, pressure information/barometer readings), or any other data recorded by a data source on or in proximity to the authentication device 115.

For simplicity, the authentication device 115 is described herein as a mobile device. A person having ordinary skill in the art, however, would recognize that the authentication device 115 may also include any other suitable type of computing device and the techniques described herein may be applied to any other suitable computing device. Examples of authentication devices 115 and corresponding suitable computing devices may be found in U.S. Pat. No. 10,713,874, which is incorporated by reference herein in its entirety.

The identity verification system 130 may be a verification system that analyzes data and draws particular inferences from the analysis. For example, the identity verification system 130 receives characteristic data collected for a target user and performs a series of analyses to generate an inference regarding the identity of the target user. Generally, the identity verification system 130 is configured to handle a wide variety of data. Accordingly, as described herein, characteristic data collected for a target user refers to both motion data and/or non-motion data. In addition to visual characteristics, target users may be characterized with particular movements and motion habits. Motion data, as described herein, describes not only a particular movement by a target user, but also additional considerations, for example the speed at which the motion occurred, or the various habits or tendencies associated with the motion. By identifying one or a combination of particular movements based on data captured by motion sensors the system may be able to identify a user from a population of users. Although techniques and embodiments described herein, may be described with reference to both non-motion and motion data, a person having ordinary skill in the art would recognize that those techniques and embodiments may be applied to motion data, non-motion data, or a combination therefore (more generally referred to as “characteristic data”).

The identity verification system 130 includes logical routines that perform a variety of functions including checking the validity of the incoming data, parsing and formatting the data if necessary, passing the processed data to a database server on the network 140 for storage, confirming that the database server has been updated, and identifying the user. The identity verification system 130 communicates, via the network 140, the results of the identification and the actions associated with the identification to the computing device 110 for presentation to a user via a visual interface.

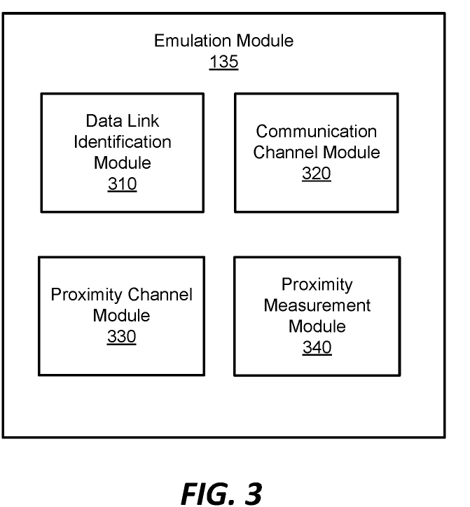

The identity verification system 130 comprises an emulation module 135, which is further described below with reference to FIG. 3. The emulation module 135 provides an application programming interface (API) to the emulation application 125 of the authentication device 115 to establish a communication channel 120 between a data link circuit 111 and a data link circuit 117. As described herein, a communication channel 120 is characterized by the data link circuits 111 and 117 serving as endpoints for a communication path between a data link circuit 111 of the secured asset 110 and a data link circuit 117 of the authentication device 115. The communication channel 120 may include any technically feasible combination of data links capable of transmitting digital data. In one embodiment, the physical data links of a communication channel 120 include, but are not limited to, wireless data links (e.g., Bluetooth, WiFi, or any other suitable electromagnetic radio frequency signal), wired data links, optical data links, acoustic data links (e.g., audible or ultrasonic), or a combination thereof. In some embodiments, the communication channel 120 may include multiple segments between data link circuits 111 and 117 with different properties, types, and data transmission rates (e.g., Bluetooth, WiFi, LTE, wired Ethernet, optical fiber, microwave data links, satellite data links etc.).

The emulation module 135 may additionally verify that the authentication device 115 is within a threshold distance of the secured asset 110 through a proximity channel (not shown). Similar to the communication channel 120, the proximity channel may be a wireless channel, a wired channel, an acoustic channel, an optical channel (e.g., an image), or any other suitable data link circuit 111 or 117. Accordingly, the emulation module 135 may determine a proximity channel between a combination of data link circuits 111 and 117 and the emulation application 125 selects data link circuits based on the determined proximity channel.

The emulation module 135 and the emulation application 125 may cooperatively establish the communication channel 120 between the secured asset 110 and the authentication device 115. In a first embodiment, the emulation module 135 determines the communication channel and the emulation application 125 selects the appropriate data link circuit(s) 117 based on the determination. In such embodiments, the emulation module 135 determines the communication channel based on the availability and state of both data link circuits 111 of the secured asset 110 and data link circuits 117 of the authentication device 115. The emulation module 135 may characterize the state of each available data link circuit 111 and data link circuit 117. Based on the characterization, the emulation module 135 selects a combination of data link circuits 111 and 117 and determines the communication channel 120 between the selected combination of data link circuits. The emulation module 135 selects the necessary data link circuits 111 to establish the communication channel 120 from asset-side. The emulation application 125 receives the determined communication channel 120 and selects the necessary data link circuits 117 to establish the communication channel from the device-side. In a second embodiment, the emulation module 135 and the emulation application 125 cooperatively characterize multiple potential communication channels based on factors including, but not limited to, packet loss, packet latency, physical properties of the potential communication channel 120 (e.g., local radio frequency noise and channel utilization). Accordingly, in the second embodiment, the emulation module 135 and the emulation application 125 cooperatively determine the communication channel 120 before selecting the necessary data link circuits at either end of the communication channel 120. The emulation module 135 and emulation application 125 may also implement the techniques discussed herein to establish a proximity channel between the secured asset 110 and the authentication device 115.

The identity verification system 130 is illustrated in FIG. 1 as being a separate system from the secured asset 110 that is wirelessly coupled to the secured asset 110. In the illustrated embodiment, outputs and determinations generated by the identity verification system 130 are transmitted to the secured asset 110 with instructions for the secured asset to grant or deny access to the target user. However, a person having ordinary skill in the art would appreciate that the components of the identity verification system 130 or the entirety of the identity verification system 130 may be integrated into the secured asset 110, for example as software device drivers executing on an operating system of the secured asset 110. An example of the identity verification system 130 may be found in U.S. Pat. No. 10,713,874, which is incorporated by reference herein in its entirety.

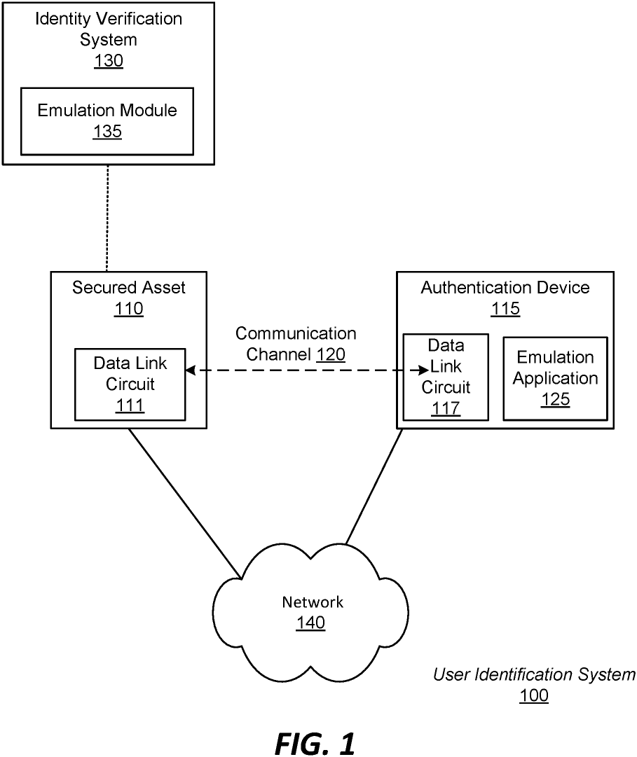

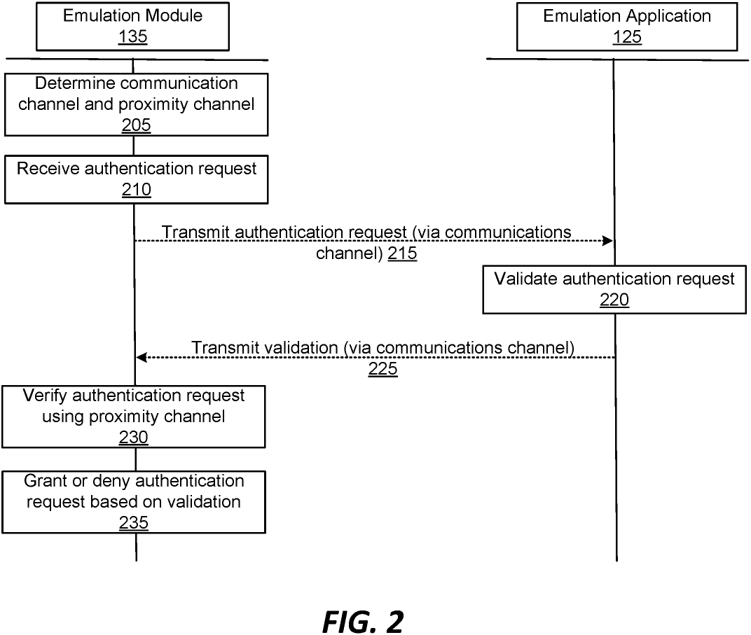

The network 140 represents the various wired and wireless communication pathways between the authentication device 115, the secured asset 110, and the identity verification system 130, which may be wireless coupled to the secured asset 110 or integrated into the hardware of the secured asset 110. Network 140 uses standard Internet communications technologies and/or protocols. Thus, the network 140 can include links using technologies such as Ethernet, IEEE 802.11, integrated services digital network (ISDN), asynchronous transfer mode (ATM), etc. Similarly, the networking protocols used on the network 140 can include the transmission control protocol/Internet protocol (TCP/IP), the hypertext transport protocol (HTTP), the simple mail transfer protocol (SMTP), the file transfer protocol (FTP), etc. The data exchanged over the network 140 can be represented using technologies and/or formats including the hypertext markup language (HTML), the extensible markup language (XML), a custom binary encoding etc. In addition, all or some links can be encrypted using conventional encryption technologies such as the secure sockets layer (SSL), Secure HTTP (HTTPS) and/or virtual private networks (VPNs). In another embodiment, the entities can use custom and/or dedicated data communications technologies instead of, or in addition to, the ones described above. In alternate embodiments, components of the identity verification system 130, which are further described with reference to FIGS. 2-7 may be stored on the secured asset 110.

Turning now to FIG. 2, illustrated is an interaction diagram for communicating data between a secured asset and an authentication device 115 to validate an authentication request, according to one embodiment. The emulation module 135 determines 205 a communication channel and a proximity channel. In response, the emulation module 135 selects data link circuits at the computer system (e.g., the secured asset 110) and the emulation application 123 selects data link circuits at the authentication device 115. When a target user attempts to access the computer system, the identity verification system 130 determines whether to authenticate the target user’s access request and grant the target user access to the computer. Accordingly, the identity verification system 130 encodes the authentication request into a signal and transmits the encoded to signal to the emulation module 135 (e.g., via an API request), which receives 210 the request. The authentication request may include one or more underlying requests. Accordingly, the techniques described herein may be applied to any authentication process suitable for implementation by the identity verification system 130. In some embodiments, the authentication request may include one or more API calls (e.g., function calls, method calls, messages, etc.) to the emulation module 135. In other embodiments, the emulation module 135 may be stored within a user and/or kernel execution space of a primary processor circuit of the computer system or in a secondary processor circuit complex of the computer system.

The emulation module 135 transmits 215 the authentication request (i.e., the encoded signal from a data link circuit at the computer system to a corresponding data link circuit at the authentication device 115 (via the communication channel 120). In one embodiment, the emulation module 135 presents an API corresponding to device driver for a locally emulated smart card and the authentication request comprises at least one application protocol data unit (APDU) certificate request.

The emulation application 125 extracts the authentication request from the encoded signal and validates 220 the authentication request. The emulation application 125 encodes a reply including the validated authentication request and transmits 225 the reply from the data link circuit at the authentication device 115 to the corresponding data link circuit at the computer system. The emulation module 135 extracts the validation from the encoded reply and verifies 230 the authentication request using the proximity channel. Once verified, the emulation module 135 or any other suitable component of the identity verification system 130 may grant 235 or deny the authentication request based on whether or not the emulation application 125 validated the authentication request.

The identity verification system 130 may perform the process illustrated in FIG. 2 in response to one or more authentication requests generated when a target user attempts to access the secured asset 110. In some embodiments, each authentication request may require a single validation. In other embodiments, a single authentication request may require multiple validations (e.g., repeated cycles of the process illustrated in FIG. 2).

### Channel Selection for Multipath Authentication

As discussed herein, the emulation module 135 determines a communication channel for transmitting digital data between a secured computer system and an authentication device 115. The emulation module 135 additionally determines a proximity channel for transmitting digital data to determine the proximity of an authentication device 115 to a computer system.

FIG. 3 s a block diagram of an example system architecture of the emulation module 135, according to one embodiment. The emulation module 135 includes a data link identification module 310, a communication channel module 320, a proximity channel module 330, and a proximity measurement module 340. In some embodiments, the emulation module 135 includes additional modules or components. In some embodiments, the functionality of components emulation module 135 may be performed by other components of the identity verification system 130 or the secured asset 110.

Before determining a communication channel, the data link identification module 310 determines the availability of data link circuits at both the computer system (e.g., the secured asset 110) and the authentication device 115. As discussed herein, data link circuits may be wireless circuits, wired circuits, acoustic circuits, optical circuits, or a combination thereof.

The data link identification module 310 may identify available data link circuits based on system hardware information for both the computer system and the authentication device 115. As described herein, system hardware information includes, but is not limited to, device status information for one or more different data link circuit device drivers installed and/or executing within the computer system, a list of devices discovered within the computer system, information resulting from probing one or more different hardware circuits within the computer system, or a combination thereof.

In one embodiment, after the data link identification module 310 identifies data link circuits available at the computer system and the authentication device 115, the communications channel 320 attempts to establish a communication channel between each data link circuit 111 at the secured asset 110 with any available data link circuit 117 at the authentication device 115. If the communication channel 320 determines that a potential communication channel cannot be established by either the computer system, the authentication device 115, or both, the communication channel 320 determines that the potential communication channel is not available.

For each available data link circuit, the communications channel module 320 determines the state of the data link circuit. The communications channel module 320 measures operation metrics (also referred to herein as “measurable attributes” or “attributes”) for each available data link including, but not limited to, a current a current signal strength, a noise level, an error rate, a dropped packet count, a dropped packet rate, sampling channel (i.e., frequency) occupancy information, a latency time (e.g., a “ping time”) or any other suitable network performance statistic. The communications channel 320 sequentially evaluates each available data link circuit by comparing the determined state of each data link circuit to a set of threshold requirements. Just as the operation metrics measured for various data link circuit may differ depending on the type of data link circuit (e.g., wired or wireless) or depending on intrinsic properties of each data link circuit, the communications 320 may compare operation metrics for each data link circuit to a different set of threshold requirements depending on the data link circuit.

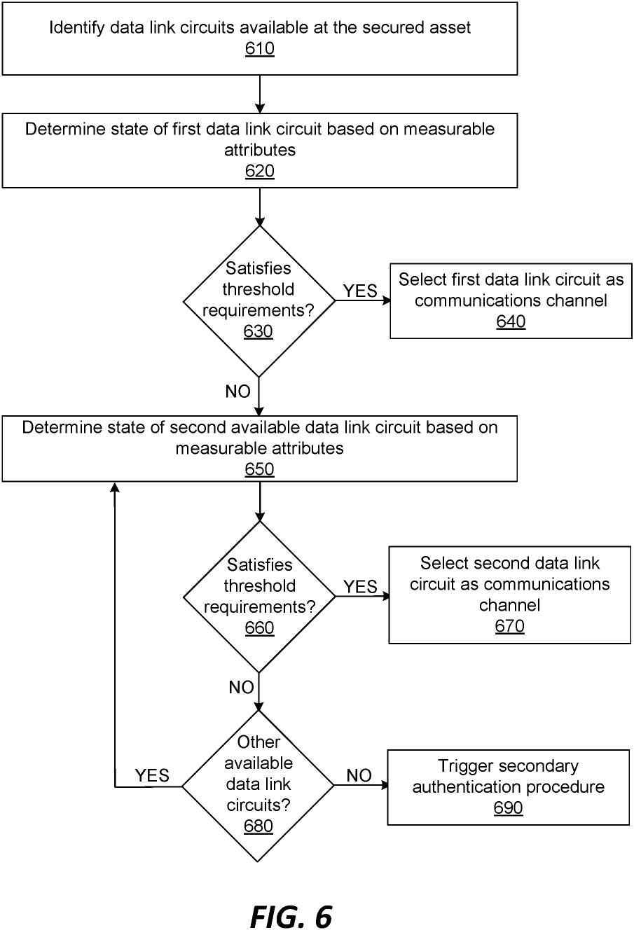

Before sequentially evaluating the available data link circuits, the communications channel 320 may prioritize or rank the available data link circuits based on performance attributes of a potential communication channel involving each available data link circuit, for example overall reliability and efficiency. The communication channel module 320 first compares the highest priority or top-ranked data link circuit to the appropriate set of threshold requirements. If the state of the data link circuit satisfies the set of threshold requirements (further described below with reference to FIG. 6), the communications channel module 320 selects the first data link circuit as an endpoint for a communications channel between the computer system and the authentication device 115. If the state of the data link circuit does not satisfy the set of threshold requirements, the communication channel 320 compares the data link circuit with the next priority to the appropriate set of the threshold requirements. The communications channel module 320 repeats this process for each available data link circuit according to the priority of data link circuits until one satisfies the set of threshold requirements. If no data link circuits satisfy the set of threshold requirements, the communications channel module 320 triggers a secondary authentication procedure to authenticate the target user.

Functionality and operation of the communication channel module 320 is further described below with reference to FIG. 6.

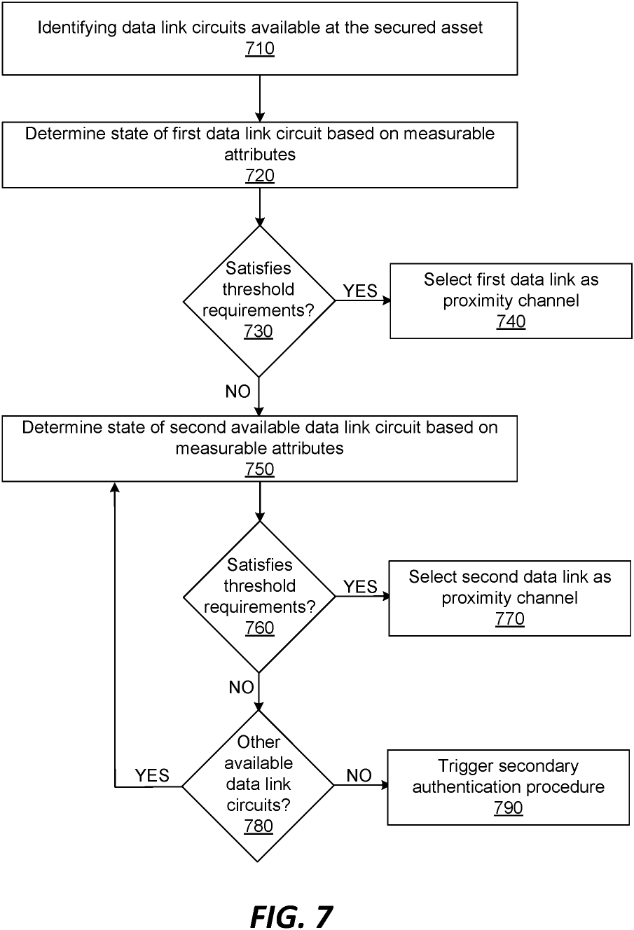

The proximity channel module 330 may implement the same techniques discussed throughout with regards to the communication channel module 320 to select data link circuits at the computer system and the authentication device 115 as endpoints for a proximity channel and determine the proximity channel module 330. Functionality and operation of the proximity module 330 is further described below with reference to FIG. 7.

The proximity channel may include any technically feasible combination of a local wireless signal (e.g., Bluetooth, WiFi, or any other suitable electromagnetic radio frequency signal), an acoustic signal (e.g., audible or ultrasonic), a vibration or motion signal (e.g., haptic transducer, accelerometer, shared location signals (e.g., global positioning signal), or any other measurable physical signals.

In one embodiment, the communication channel module 320 establishes a communication channel with the authentication device 115 via a Bluetooth data link. The emulation application 125 may characterize the Bluetooth radio frequency environment with respect to noise and channel occupancy before transmitting the characterization to the emulation module 135. As described herein, “channel occupancy” is a measurement indicative of a time occupancy ratio for a particular communication channel (e.g., whether the communication channel is carrying traffic 1%, 5%, 50% of the time within a measurement interval). In addition, the proximity channel module 330 may separately characterize Bluetooth radio frequency environment with respect to noise and channel occupancy.

The proximity channel module 330 may establish a proximity channel between the data link circuit 111 and the data link circuit 117 if both characterizations are within a threshold similarity. If the two characterizations are within a threshold similarity, the proximity channel module 330 may establish a proximity channel confirming that radio frequency measurements are sufficient proof of the authentication device’s 115 proximity to the secured asset 110. The threshold similarity provides a mechanism to accommodate differences between the computer system and the authentication device 115. As described herein, the threshold similarity indicates that two or more devices (e.g., the computer system and the authentication device 115) each independently measure similar (within a threshold) environmental parameters), which indicate the likely proximity of the two devices. In addition to the examples provided herein, a person having ordinary skill in the art would appreciate that any other technique may be implemented to measure and determine environmental similarity between two or more devices without departing the scope of various embodiments. For example, where the threshold similarity is determined based on channel occupancy, the communication channel module 320 should measure almost identical channel occupancy measurements between the computer system and the authentication device 115 if both measurements are taken in close proximity to each other.

For example, the proximity channel module 330 may determine that both characterizations satisfy the threshold similarity if the most recently measured average channel occupancy for the computer system is within a threshold deviation (e.g., 10%) of the most recently measured average channel occupancy for the authentication device 115.

The communication channel module 320 and the proximity channel module 330 may select the same type or different types of data link circuits for establishing the communications channel and the proximity channel given the variance in availability and reliability of physical data links. For example, a first candidate channel may exist between a Bluetooth data link circuit at the computer system and a Bluetooth data link circuit at the authentication device 115, but Bluetooth signals transmitted between the data link circuits may be noisy and unreliable. A second, more reliable, candidate channel may exist between a wired data link circuit at the computer system (e.g., a wired Ethernet connection) and wireless data link circuit at the authentication device 115 (e.g., a long term evolution (LTE) wireless carrier connection). In this example, the emulation module 135 may select the second candidate channel as the communication channel and the first candidate channel as the proximity channel. Accordingly, the emulation module 135 may establish individual channels between different types of data link circuits (e.g., a channel between a wired data link circuit and a wireless data link circuit). Additionally, the emulation module 135 may select different and independent channels as the communication channel and the proximity channel.

The proximity measurement module 340 measures proximity based on any combination of wireless signals, acoustic signals, vibration or motion signals, shared location signals, or any other measurable physical signals.

In some embodiments, the proximity channel is an acoustic path between acoustic device links of the computer system and the authentication device 115. In such embodiments, the proximity measurement module 340 establishes proximity by modulating the authentication request into an audio signal that is transmitted along the acoustic channel. In one embodiment, the computer system transmits a nonce code encoded within a modulated audio signal across the acoustic channel and the emulation application 125 receives the secret nonce code by demodulating the audio signal. The emulation application 125 transmits the nonce code back to the computer system along the audio channel or a different secondary communication channel (e.g., an internet connection). The emulation application 125 may functionally validate the authentication request by transmitting the correct nonce code back to the emulation module 135. If the emulation application 125 validates the authentication request in this manner, the proximity measurement module 340 may verify the proximity of the authentication device 115 to the secured asset 110. In another embodiment, the emulation module 135 may generate the nonce code as a random number. The emulation module 135 may randomly generate the nonce code algorithmically, based at least in part on random physical measurements, or both. In yet another embodiment, the emulation module 135 may generate the nonce code using a private key and a sequence counter. In addition to the techniques described herein, the nonce code may be generated using any technically feasible technique.

In some embodiments, the proximity measurement module 340 may measure the proximity of the authentication device 115 using a single-use QR code displayed on the computer system and read by an application installed on the authentication device 115. For example, the authentication device 115 reads a QR code displayed on a computer system using an integrated camera commonly available on mobile devices. The emulation application 110 extracts data from the QR code and transmits the data back to the computer system through a connection between data network (e.g., the Internet, an intranet, etc.). In one example implementation, the emulation application 125 extract data from the QR code including a nonce code of more than sixteen bits (or alternatively more than five hundred bits). In another example implementation, the emulation application 125 opens a universal location record (URL) encoded by the QR code. The URL may cause a cloud service to transmit a proximity validation code back to the proximity measurement module 340 through the network 140. In such embodiments, the proximity measurement module 340 verifies that the authentication device 115 is within a threshold proximity of the computer system when the authenticating device 110 successfully reads the QR code and transmits proof of reading the QR code back to the proximity measurement module 340.

In another example embodiment, the proximity measurement module 340 encodes and displays a nonce code in the form of a QR code. After reading the QR code using an integrated camera, the authentication device 115 generates and displays a code sequence. The computer system displays a prompt for the target user to manually enter the code sequence. When the target user correctly enters the code sequence, the proximity measurement module 340 verifies that the authentication device 115 is within a threshold proximity of the computer system. The code sequence may be generated by cryptographically signing and/or hashing the nonce code encoded in the QR code. The proximity measurement module 340 may implement this technique under circumstances where proximity is required to grant the target user access to the computer system but neither the computer system nor the authentication device 115 are able to connect to a data network.

Additionally, the proximity measurement module 340 may record and transmit physical addresses recorded for Bluetooth devices as evidence of an authentication device’s 115 proximity to a secured asset 110. More generally, the proximity measurement module 340 may continuously monitor radio frequency channels for evidence of continuous proximity to an authentication device.

The proximity measurement module 340 may measure the proximity of the authentication device 115 and the computer system (or another secured asset or a target user) using any technique compatible with the secured asset 110, the authentication device 115, or the circumstances surrounding the secured asset 110. More information regarding proximity-based measurements using an authentication device 115 or any other suitable computing device may be found in U.S. Pat. Application No. 17/542,289 and 17/542,294, both of which are incorporated by reference herein in their entirety.

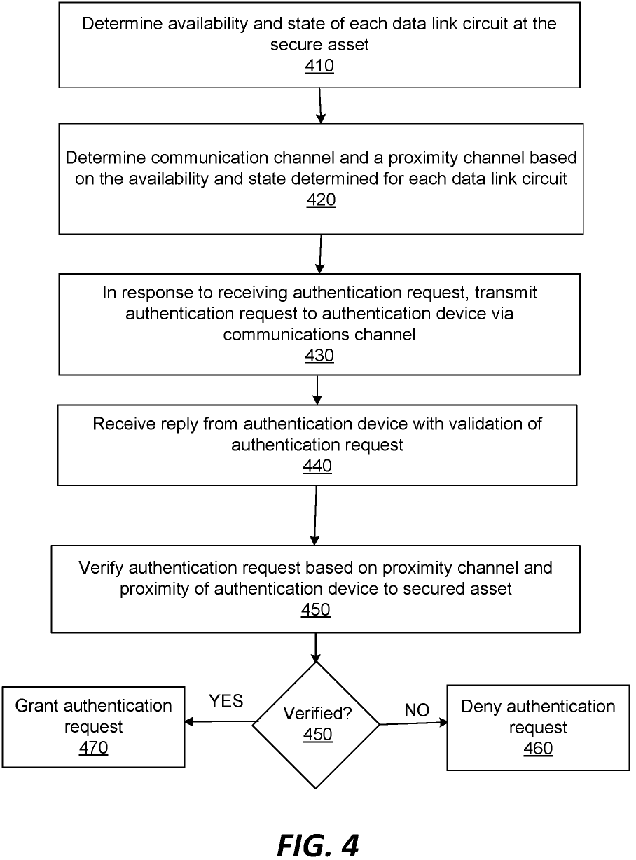

FIG. 4 illustrates an example process for verifying an authentication request from the perspective of the emulation module 135 of the secured asset 110, according to one embodiment. The emulation module (e.g., the emulation module 135) determines 410 an availability and state of each data link circuit at the computer system (e.g., the secured asset 110). The emulation module 135 identifies available data link circuits based on system hardware information (as described herein) and characterizes the state of available data link circuits based on operation metrics for each data link circuits (as described herein).

The emulation module 135 determines 420 a communication channel and a proximity channel based on the state of each available data link circuit.

In some embodiments, the emulation module 135 performs steps 410 and 420 prior to receiving an authentication protocol request. In other embodiments, the emulation module 135 performs steps 410 and 420 in response to receiving an authentication request. When the identity verification system 130 receives an authentication request, the emulation module 135 transmits the authentication request to the emulation application 125 of an authentication via the determined communications channel. Before transmission, the emulation module 135 encodes the authentication request into a packet structure or a physical frame structure suitable for transmission over the determined communications channel. The emulation module 135 may implement any technically feasible encoding structure. As discussed herein, the emulation application 125 validates the authentication request and transmits its reply to the emulation module 135. The emulation application 125 may encode its reply and the results of the validation into encapsulated packet or frame. Accordingly, the emulation module 135 receives 440 the reply from the authentication and extracts the reply from the encapsulated packet or frame.

The emulation module 135 verifies 450 the authentication request by measuring the proximity of the authentication device 115 to the secured asset 110 using the proximity channel. In some embodiments, the emulation module 135 measures the proximity of the authentication device 115 based on direct communications between the computer system and the authentication device 115, for example through a local radio frequency communications data link. The emulation module 135 may measure proximity using signal signatures including, but not limited to, signal levels, noise levels, round trip time, channel occupancy. Techniques for measuring the proximity of the authentication device 115 to the secured asset 110 are described herein with reference to the proximity measurement module 340 in FIG. 3.

The emulation module 135 generates a response to the initial authentication request based on whether the request was validated by the emulation application 125 and/or whether the request was verified using the proximity channel. The response may comprise an application programming interface (API) (e.g., a function nor method return, a message to a designated handler, a function or method call back, etc.). The response may additionally, or alternatively, include a confirmation indicating that the authentication device 115 is within proximity to the computer system along with the reply received from the emulation application 125. In embodiments where the emulation application 125 validates the authentication request and the emulation module 135 verifies the authentication request using the proximity channel, the identity verification system 130 grants 470 the authentication request. In embodiments where either the emulation application 125 does not validate the authentication request or the emulation module 135 determines that the authentication device 115 is not in proximity to the secured asset 110, the user verification system denies 460 the authentication request.

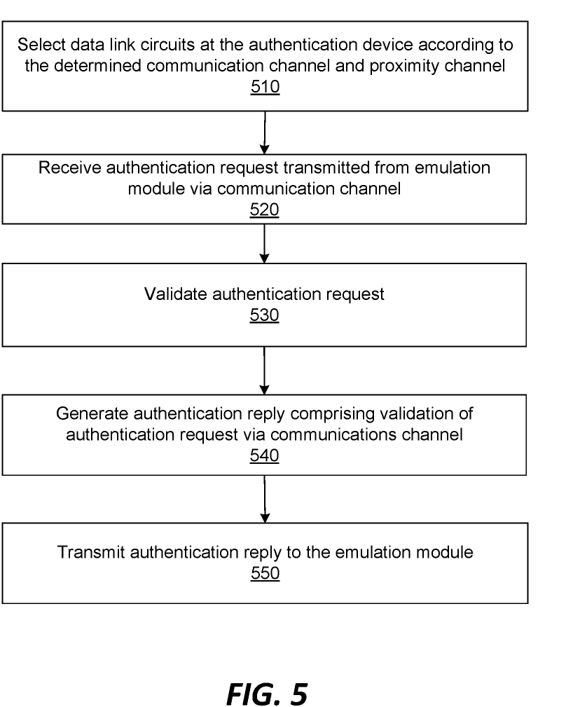

FIG. 5 illustrates an example process for verifying an authentication request from the perspective of the emulation application 125 of the authentication device 115, according to one embodiment. As discussed herein, the emulation module 135 determines a communication channel and a proximity channel based on the available data link circuits and the state of each available data link circuit. The emulation application 125 selects 510 data link circuits at the authentication device 115 corresponding to the determined communication channel and the determined proximity channel.

The emulation application 125 receives 520 the authentication request transmitted from the identity verification system 130 via the determined communication channel. Upon receipt of the authentication request, the emulation application 125 extracts the authentication request from the encoded packet or frame received from the emulation module 135. The emulation application validates 530 the authentication request, for example by verifying that the target user intended to request access to the secured asset 110. In one embodiment, the authentication request is electronically signed by the computer system (e.g., a cryptographic signature) and the emulation application 125 validates the request by verifying that the computer system originated the authentication protocol request. The emulation application 125 may validate 530 the authentication request using any other suitable technique or source and construction of the authentication request. In addition to the embodiment involving a cryptographic signature described herein, a person having ordinary skill in the art would appreciate that the emulation application 125 may implement any suitable technique to validate the authentication request.

Based on the results of the validation, the emulation application 125 generates 540 an authentication reply. If the emulation application 125 validates the authentication request, the emulation application 125 generates an authentication reply comprising instructions for the emulation module 135 to measure the proximity of the authentication device 115 to the secured asset 110 before granting access to the secured asset 110. If the emulation application 125 does not validate the authentication request, the emulation application 125 generates an authentication reply comprising instructions for the emulation module 135 to deny access to the secured asset 110 regardless of the proximity of the authentication device 115 to the secured asset 110.

In some embodiments, the emulation application 125 generates the authentication reply by transmitting the authentication request to an authentication circuit (at the authentication device 115) that validates the authentication request, generates authentication replies, or both. In one embodiment, the authentication circuit comprises a device disposed within the authentication device 115 (e.g., a smart card) and in communication with the emulation application 125. In another embodiment, the authentication circuit comprises a secure enclave processor programmed to perform the functions of a smart card device and/or any other technically feasible security device or key. In alternative embodiments, the emulation application 125 directly generates the authentication reply based on the authentication request and locally stored credential data (or a digital key). A person having ordinary skill in the art would readily understand that numerous techniques may applied to generate an authentication reply based on the overall system architecture of the authentication device 115.

The emulation application 125 transmits 550 the authentication reply to the emulation module 135 through the selected communication channel (e.g., the communication channel 120). In one embodiment, emulation application 125 additionally encodes the authentication reply into a packet structure or a physical frame structure appropriate for the selected communications channel prior to transmission.

### Determining Communication Channel and Proximity Channel

As described herein, the emulation module 135, specifically the communication channel module 320 and the proximity channel module 330, determine communication channels and proximity channels based on the availability and state of data link circuits at the computer asset (e.g., the secured asset 110) and the authentication device 115.

FIG. 6 illustrates an example process for determining a communication channel at the emulation module 135, according to one embodiment. Although aspects of FIG. 6 are described with reference to the data link identification module 310 or the communication channel module 320, a person having ordinary skill in the art would appreciate that all aspects of FIG. 6 may be performed by any technically capable component of the emulation module 135.

As described herein, the emulation module 135 determines a communication channel between a secured asset 110 (e.g., a computer system) and an authentication device 115 to communicate digital data between the computer system and the authentication device 115. The emulation module 135 at the computer system (e.g., the data link identification module 310) identifies 610 data link circuits available at the secured asset 110 using the techniques discussed herein, for example hardware specifications for the computer system.

The communication channel module 320 of the emulation module 135 prioritizes (or ranks) the available data link circuits based on the expected effectiveness and performance of a communication channel involving each data link circuit. For example, the communication channel module 320 may prioritize a wired Ethernet data link circuit over either a wireless Bluetooth or Wi-Fi data link circuit. When prioritizing and determining the state of an available data link circuit, the communication channel module 320 measures attributes of the data link circuit including, but not limited to, signal strength, error rate, dropped packet rate, channel occupancy, or ping latency. The communication channel module 320 may measure attributes of the data link circuit periodically as an ongoing process and characterize the link based on a series of measurements recorded within a specified time period (e.g., seconds, minutes, or hours). In such embodiments, the communication channel module 320 determines representative values of the attributes based on the series of measurements recorded within a specified time period and determines whether the representative values for the attributes of the data link circuit satisfy threshold values defined for the data link circuit.

The communication channel module 320 determines 620 the state of the first data link circuit based on measurable attributes of the data link circuit. If the communication channel module 320 determines 630 that the state of the first data link circuit satisfies a set of threshold requirements, the communication channel module 320 selects 640 the first data link as the endpoint at the computer system for the communication channel between the computer system and authentication device 115. As described herein, the set of threshold requirements represent measurable attributes for evaluating the computer system, the authentication device 115, a potential communication channel involving the available data link circuit, or a combination thereof. In some embodiments, the state of the first data link circuit must satisfy one or more of the threshold requirements for the communication channel module 320 to select the first data link as an endpoint for the communications channel. In other embodiments, the state of the first data link circuit must satisfy all of the threshold requirements for the communication channel module 320 to select the first data link as an endpoint for the communications channel.

In one embodiment, the set of threshold requirements require the signal strength measured from the authentication device 115 be greater than a predefined threshold for reliable data transmission, the packet (e.g., frame) loss rate measured for the authentication device 115, and the channel occupancy rate measured for the potential communication channel including the data link circuit be below a predefined threshold for reliable data transmission, any other technically relevant attribute of the data link circuit, or a combination thereof. Each attribute of the set of threshold requirements (e.g., signal strength, packet loss rate, and channel occupancy) may be measured by the authentication device 115 (e.g., mobile device), the secured asset 110 (e.g., computer system), or both, based on overall implementation and design specifications of the authentication device 115 and the secured asset 110. In addition to the attributes described above, the emulation module 135 may measure and store any other attributes as part of a channel selection process.

If the communication channel module 320 determines 630 that the state of the first data link circuit does not satisfy the set of threshold requirements, the communication channel module 320 determines 650 a state of a second available data link circuit based on measurable attributes of the second data link circuit. In some embodiments, the communication channel module 320 applies the same set of threshold requirements when evaluating each available data link circuit. In other embodiments, the communication channel module 320 applies a different set of threshold requirements to each available data link circuit, where each set of threshold requirements characterize measurable attributes specific to the data link circuit. If the communication channel module 320 determines 660 that the state of the second data link circuit satisfies the set of threshold requirements, the communication channel module 320 selects 670 the second data link as the endpoint at the computer system for the communication channel between the computer system and the authentication device 115.

If the communication channel module 320 determines 660 that the state of the second data link circuit does not satisfy the set of threshold requirements, the communication channel module 320 determines 680 whether any other data link circuits are available at the computer system. If other data link circuits are available, the communication channel module 320 repeats steps 650, 660, 670, and 680 until one of the other available data link circuits satisfies the threshold set of requirements and the communication channel module 320 selects that available data link circuit as the endpoint at the computer system for the communication channel between the computer system and the authentication device 115.

If there are no other available data link circuits or if no available data link circuit satisfies a set of threshold requirements, the communication channel module 320 triggers 690 a secondary authentication procedure, which may be defined and/or limited by a set of system administrative policies. In one embodiment, the secondary authentication procedure causes the computer system to generate and display a one-time QR code, which the authentication device 115 reads. When the authentication device 115 reads the QR code, the emulation application 125 generates a one-time authentication code, which the target user inputs to the computer system. In another embodiment, the computer system and the emulation application 125 of the authentication device 115 communicate through an audio channel by modulating authentication codes as audio signals over the audio channel.

As an example, illustrative of the process illustrated in FIG. 6, the emulation module 135 determines a state of a first wireless data link circuit - e.g., a Bluetooth wireless data link circuit. The communication channel module 320 determines the state of the Bluetooth wireless data link circuit by measuring one or more attributes of the Bluetooth data link circuit including, but not limited to, a strength of the Bluetooth signal from the authentication device 115, a packet (e.g., frame) loss rate from the authentication device 115, an overall Bluetooth channel occupancy for the potential communication channel, any other technically relevant property of the Bluetooth connection between the computer system and the authentication device 115, or a combination thereof. If the determined state of the Bluetooth wireless data link circuit satisfies the set of threshold requirements, the communication channel module 320 selects the Bluetooth data link circuit as an endpoint of the communication channel.

If the determined state of the Bluetooth wireless data link circuit does not satisfy the set of threshold requirements, the communication channel module 320 determine a state of a second wireless data link circuit - e.g., a Wi-Fi wireless data link circuit by measuring one or more attributes of the Wi-Fi data link circuit. In one embodiment, the communication channel module 320 measures the same attributes measured for the Bluetooth wireless data link circuit (described herein) and compares the Wi-Fi wireless data link circuit to the same set of threshold requirements. If the determined state of the Wi-Fi wireless data link circuit satisfies the set of threshold requirements, the communication channel module 320 selects the Wi-Fi data link circuit as an endpoint of the communication channel.

If the determined state of the Wi-Fi wireless data link circuit does not satisfy the set of threshold requirements, the communication channel module 320 determines a state of a third wired data link circuit - an Ethernet wired data link circuit by measuring one or more attributes of the Ethernet data link circuit. The communication channel module 320 determines the state of the Ethernet wired data link circuit by measuring one or more attributes of the Ethernet data link circuit including, but not limited to, a ping latency for the authentication device 115, a ping latency for a cloud server system, a packet (e.g., frame) loss rate from the authentication device 115, any other technically relevant property of the Ethernet connection between the computer system and the authentication device 115, or a combination thereof. Because the attributes measured for the Ethernet wired data link circuit differ from the attributes measured for the Bluetooth and Wi-Fi wireless data link circuits, the communication channel module 320 applies a second set of threshold requirements to evaluate the state of the Ethernet data link circuit.

In one embodiment, the set of threshold requirements require the measured ping latency from the authentication device 115 be greater than a predefined threshold for reliable data transmission, the measured ping latency to the cloud server be below a predefined threshold for reliable data transmission. Each attribute of the set of threshold requirements (e.g., ping latency and packet loss rate) may be measured based on overall implementation and design specifications of the authentication device 115 and the cloud server. If the determined state of the Ethernet wired data link circuit satisfies the second set of threshold requirements, the communication channel module 320 selects the Ethernet data link circuit as an endpoint of the communication channel. If the determined state of the Ethernet wired data link circuit does not satisfy the second set of threshold requirements and there are no other available data link circuits, the communication channel module 320 triggers the secondary authentication procedure described herein.

FIG. 7 illustrates an example process for determining a proximity channel at the emulation module 135, according to one embodiment. The emulation module 135 determines a proximity channel between a secured asset 110 (e.g., a computer system) and an authentication device 115 to determine a proximity between the computer system and the authentication device 115. Although aspects of FIG. 7 are described with reference to the data link identification module 310 or the proximity channel module 330, a person having ordinary skill in the art would appreciate that all aspects of FIG. 6 may be performed by any technically capable component of the emulation module 135. The proximity channel module 330 may implement the same or similar techniques and processes as the communication channel module 320 does to determine a communication channel, for example the techniques and processes described above with reference to FIG. 6.

The emulation module 135 at the computer system (e.g., the data link identification module 310) identifies 710 data link circuits available at the secured asset 110 using the techniques discussed herein with regards to FIG. 6, for example hardware specifications for the computer system. The proximity channel module 330 of the emulation module 135 prioritizes (or ranks) the available data link circuits based on the expected effectiveness and performance of a proximity channel involving each data link circuit. For example, the proximity channel module 330 may prioritize a wired Ethernet data link circuit over either a wireless Bluetooth or Wi-Fi data link circuit. When prioritizing and determining the state of an available data link circuit, the proximity channel module 330 measures attributes of the data link circuit, for example according to the above description of the communication channel module 320. In some embodiments, the proximity channel module 330 accesses the priority or ranking of available data link circuits determined by the communication channel module 320.

As described above regarding the communication channel module 320, the proximity channel module 330 determines 720 the state of the first data link circuit based on measurable attributes of the data link circuit. If the proximity channel module 330 determines 730 that the state of the first data link circuit satisfies a set of threshold requirements, the proximity channel module 330 selects 740 the first data link as the endpoint at the computer system for the proximity channel between the computer system and authentication device 115. As described herein, the set of threshold requirements represent measurable attributes for evaluating the computer system, the authentication device 115, a potential proximity channel involving the available data link circuit, or a combination thereof. In some embodiments, the state of the first data link circuit must satisfy one or more of the threshold requirements for the communication channel module 320 to select the first data link as an endpoint for the communications channel. In other embodiments, the state of the first data link circuit must satisfy all of the threshold requirements for the communication channel module 320 to select the first data link as an endpoint for the communications channel. If the proximity channel module 330 were to compare the determined state of the data link circuit to the same set of threshold requirements as the communication channel module 320, the proximity channel module 330 may access the results of the previous comparison performed by the communication channel module 330 to determine whether to select the data link as an endpoint of the proximity channel.

In one embodiments (discussed herein with regards to step 630 of FIG. 6), the set of threshold requirements require the signal strength measured from the authentication device 115 be greater than a predefined threshold for reliable data transmission, the packet (e.g., frame) loss rate measured for the authentication device 115, and the channel occupancy rate measured for the potential proximity channel including the data link circuit be below a predefined threshold for reliable data transmission, any other technically relevant attribute of the data link circuit, or a combination thereof. Each attribute of the set of threshold requirements (e.g., signal strength, packet loss rate, and channel occupancy) may be measured by the authentication device 115 (e.g., mobile device), the secured asset 110 (e.g., computer system), or both, based on overall implementation and design specifications of the authentication device 115. In addition to the attributes described above, the emulation module 135 may measure and store any other attributes as part of a channel selection process.

If the proximity channel module 330 determines 730 that the state of the first data link circuit does not satisfy the set of threshold requirements, the proximity channel module 330 determines 740 a state of a second available data link circuit based on measurable attributes of the second data link circuit. In some embodiments, the proximity channel module 330 applies the same set of threshold requirements when evaluating each available data link circuit. In other embodiments, the proximity channel module 330 applies a different set of threshold requirements to each available data link circuit, where each set of threshold requirements characterize measurable attributes specific to the data link circuit. If the proximity channel module 330 determines 760 that the state of the second data link circuit satisfies the set of threshold requirements, the proximity channel module 330 selects 770 the second data link as the endpoint at the computer system for the proximity channel between the computer system and the authentication device 115.

If the proximity channel module 330 determines 760 that the state of the second data link circuit does not satisfy the set of threshold requirements, the proximity channel module 330 determines 780 whether any other data link circuits are available at the computer system. If other data link circuits are available, the proximity channel module 330 repeats steps 750, 760, 770, and 780 until one of the other available data link circuits satisfies the threshold set of requirements and the proximity channel module 330 selects that available data link circuit as the endpoint at the computer system for the proximity channel between the computer system and the authentication device 115.

If there are no other available data link circuits or if no available data link circuit satisfies a set of threshold requirements, the communication channel module 320 triggers 690 a secondary authentication procedure, which may be defined and/or limited by a set of system administrative policies. In one embodiment, the secondary authentication procedure causes the computer system to generate and display a one-time QR code, which the authentication device 115 reads. When the authentication device 115 reads the QR code, the emulation application 125 generates a one-time authentication code, which the target user inputs to the computer system. In another embodiment, the computer system and the emulation application 125 of the authentication device 115 communicate through an audio channel by modulating authentication codes as audio signals over the audio channel.

Recalling the illustrative example described with reference to FIG. 6, the proximity channel module 330 determines a state of a first wireless data link circuit - e.g., a Bluetooth wireless data link circuit. The proximity channel module 330 determines the state of the Bluetooth wireless data link circuit by measuring one or more attributes of the Bluetooth data link circuit including, but not limited to, a strength of the Bluetooth signal from the authentication device 115, a packet (e.g., frame) loss rate from the authentication device 115, an overall Bluetooth channel occupancy for the potential communication channel, any other technically relevant property of the Bluetooth connection between the computer system and the authentication device 115, or a combination thereof. If the determined state of the Bluetooth wireless data link circuit satisfies the set of threshold requirements, the proximity channel module 330 selects the Bluetooth data link circuit as an endpoint of the communication channel.

If the determined state of the Bluetooth wireless data link circuit does not satisfy the set of threshold requirements, the proximity channel module 330 determines a state of a second wireless data link circuit - e.g., a Wi-Fi wireless data link circuit by measuring one or more attributes of the Wi-Fi data link circuit. In one embodiment, the proximity channel module 330 measures the same attributes measured for the Bluetooth wireless data link circuit (described herein) and compares the Wi-Fi wireless data link circuit to the same set of threshold requirements. If the determined state of the Wi-Fi wireless data link circuit satisfies the set of threshold requirements, the proximity channel module 330 selects the Wi-Fi data link circuit as an endpoint of the proximity channel.

If the determined state of the Wi-Fi wireless data link circuit does not satisfy the set of threshold requirements, the proximity channel module 330 determines a state of a third wireless data link circuit - an acoustic wireless data link circuit by measuring one or more attributes of the acoustic data link circuit. The proximity channel module 330 determines the state of the acoustic data link circuit by measuring one or more attributes of the acoustic data link circuit including, but not limited to, signal strength from the authentication device 115, data transmission rate over the acoustic data link circuit, a packet (i.e., frame) loss rate from the authentication device 115, any other technically relevant property of the acoustic connection between the computer system and the authentication device 115, or a combination thereof. Because the attributes measured for the Ethernet wired data link circuit differ from the attributes measured for the Bluetooth and Wi-Fi wireless data link circuits, the communication channel module 320 applies a second set of threshold requirements to evaluate the state of the Ethernet data link circuit.

In one embodiment, the set of threshold requirements require the measured signal strength from the authentication device 115 be greater than a predefined threshold for reliable data transmission, the measured data transmission rate over the acoustic data link be greater than a predefined threshold rate for acceptable data transmission, and the packed loss rate measured from the authentication device 115 be below a predefined threshold for acceptable data transmission. If the determined state of the acoustic data link circuit satisfies the second set of threshold requirements, the proximity channel module 330 selects the acoustic data link circuit as an endpoint of the proximity channel. If the determined state of the acoustic data link circuit does not satisfy the second set of threshold requirements and there are no other available data link circuits, the proximity channel module 330 triggers the secondary authentication procedure described above with regards to FIG. 6.

### Computing Machine Architecture

FIG. 8 is a block diagram illustrating components of an example machine able to read instructions from a machine-readable medium and execute them in a processor (or controller). Specifically, FIG. 8 shows a diagrammatic representation of a machine in the example form of a computer system 800 within which instructions 824 (e.g., software) for causing the machine to perform any one or more of the processes or (methodologies) discussed herein (e.g., with respect to FIGS. 1-7) may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment. It is noted that some or all of the components described may be used in a machine to execute instructions, for example, those corresponding to the processes described with the disclosed configurations.

The machine may be a server computer, a client computer, a personal computer (PC), a tablet PC, a set-top box (STB), a personal digital assistant (PDA), a cellular telephone, a smartphone, a web appliance, an IoT device, a wearable, a network router, switch or bridge, or any machine capable of executing instructions 824 (sequential or otherwise) that specify actions to be taken by that machine. Further, while only a single machine is illustrated, the term “machine” shall also be taken to include any collection of machines that individually or jointly execute instructions 824 to perform any one or more of the methodologies discussed herein.

The example computer system 800 includes a processor 802 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 804, and a static memory 806, which are configured to communicate with each other via a bus 808. The computer system 800 may further include visual display interface 810. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 810 may include or may interface with a touch enabled screen. The computer system 800 may also include alphanumeric input device (e.g., a keyboard or touch screen keyboard), a cursor control device 814 (e.g., a mouse, a trackball, a joystick, a motion sensor, or other pointing instrument), a storage unit 816, a signal generation device 818 (e.g., a speaker), and a network interface device 820, which also are configured to communicate via the bus 808. It is noted that the example computer system 800 need not include all the components but may include a subset.

The storage unit 816 includes a machine-readable medium 822 on which is stored instructions 824 (e.g., software) embodying any one or more of the methodologies or functions described herein. The instructions 824 (e.g., software) may also reside, completely or at least partially, within the main memory 804 or within the processor 802 (e.g., within a processor’s cache memory) during execution thereof by the computer system 800, the main memory 804 and the processor 802 also constituting machine-readable media. The instructions 824 (e.g., software) may be transmitted or received over a network 826 via the network interface device 820.

While machine-readable medium 822 is shown in an example embodiment to be a single medium, the term “machine-readable medium” should be taken to include a single medium or multiple media (e.g., a centralized or distributed database, or associated caches and servers) able to store instructions (e.g., instructions 824). The term “machine-readable medium” shall also be taken to include any medium that is capable of storing instructions (e.g., instructions 824) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

The disclosed identity verification system 130 enables enterprise systems to track and evaluate a user’s access to an operational context in real-time. Compared to conventional systems which determine a user’s access at a single point in time, the described identity verification system 130 continuously verifies a user’s identity based on characteristic data recorded by a mobile device or a combination of other sources. Because characteristics of a user’s movement and activities are unique to individual users, the identity verification system 130 is able to accurately verify a user’s identity with varying levels of confidence. Additionally, by leveraging characteristic data recorded for a user, the identity verification system 130 may not be spoofed or hacked by someone attempting to access the operational context under the guise of another user’s identity. Moreover, by continuously comparing a confidence identity value for a user to a threshold specific to an operational context, the enterprise system may revoke or maintain a user’s access.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms”" “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for systems and a process for confirming an identity based on characteristic data received from various sources through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed:

1. A non-transitory computer-readable storage medium, comprising stored instructions encoded thereon that, when executed by at least one processor, causes the processor to:
determine a state of each data link circuit available at a computer system comprising one or more data link circuits based on operation metrics measured for the data link circuit, each data link circuit to transmit digital data from the computer system;
determine a communication channel that transmits signals between the computer system and an authentication device by selecting a data link circuit at the computer system based on the state of the data link circuit;
transmit, by the communication channel, an authentication request to the authentication device, the authentication request generated in response to a target user requesting access to the computer system;
measure, responsive to receiving validation of the authentication request from the authentication device, a proximity of the authentication device to the computer system based on data transmitted through a proximity channel; and
grant, responsive to the measured proximity of the authentication device satisfying a threshold proximity, the target user access to the to the computer system.

2. The non-transitory computer-readable storage medium of claim 1, further comprising stored instructions that when executed cause the processor to:
identify each available data link circuit based on hardware specifications for the computer system.

3. The non-transitory computer-readable storage medium of claim 1, wherein the stored instructions to determine the communication channel further comprise stored instructions that when executed cause the processor to:
compare the state determined for a first data link circuit of the one or more data link circuits to a threshold requirement, the first data link circuit being a highest ranked data link circuit and the threshold requirement representing a measurable attribute for evaluating a potential communication channel involving the data link circuit; and
select the first data link circuit in response to the state of the first data link circuit satisfying the threshold requirement.

4. The non-transitory computer-readable storage medium of claim 2, wherein the stored instructions further comprise stored instructions that when executed cause the processor to:
rank each data link circuit of the computer system based on a predicted performance of a potential communication channel involving the data link circuit given the state determined for the data link circuit.

5. The non-transitory computer-readable storage medium of claim 3, wherein the stored instructions further comprise stored instructions that when executed cause the processor to:
compare, responsive to a determination that the state of the highest ranked data link circuit does not satisfy the threshold requirement, the state determined for a second data link circuit of the one or more data link circuits to the threshold requirement, the second data link circuit being a next highest ranked data link circuit; and responsive to the state of the second highest ranked data link circuit satisfying the threshold requirement, determine the communication channel by selecting the second data link circuit at the computer system.

6. The non-transitory computer-readable storage medium of claim 3, wherein the threshold requirement requires one of:
a signal strength measurement for the authentication device exceeding a threshold;
a packet loss rate measurement for the authentication device exceeding a threshold;
a channel occupancy rate measurement for the potential communication channel within a threshold for reliable data transmission; and
a latency measurement for the authentication device exceeding a threshold.

7. The non-transitory computer readable storage medium of claim 1, wherein the stored instructions further comprise stored instructions that when executed cause the processor to:
receive, by the communication channel, a characterization for a data link circuit at the computer system and a characterization of a corresponding data link circuit at the authentication device, wherein the characterizations describe measurements of signals transmitted by the data link circuit and the corresponding data link circuit;
determine a similarity between the characterization of the data link circuit at the computer system and the characterization of the corresponding data link circuit at the authentication device; and
determine, responsive to the similarity satisfying a threshold similarity, a proximity channel between the computer system and the authentication device by selection of the data link circuit at the computer system and the corresponding data link circuit at the authentication device.

8. The non-transitory computer readable storage medium of claim 7, wherein the stored instructions further comprise stored instructions that when executed cause the processor to:
compare a state of the data link circuit at the computer system to a threshold requirement, wherein the threshold requirement represents a measurable attribute for evaluating a proximity communication channel involving the data link circuit; and
determine, responsive to the state of the data link circuit satisfying the threshold requirement, the proximity channel by selection of the data link circuit at the computer system and the corresponding data link circuit at the authentication device.

9. A method comprising:
determining a state of each data link circuit available at a computer system comprising one or more data link circuits based on operation metrics measured for the data link circuit, each data link circuit to transmit digital data from the computer system;
determining a communication channel to transmit signals between the computer system and an authentication device by selection of a data link circuit at the computer system based on the state of the data link circuit;
transmitting, by the communication channel, an authentication request to the authentication device, the authentication request generated in response to a target user requesting access to the computer system;
measuring, responsive to receiving validation of the authentication request from the authentication device, a proximity of the authentication device to the computer system based on data transmitted through a proximity channel; and
granting, responsive to the measured proximity of the authentication device satisfying a threshold proximity, the target user access to the to the computer system.

10. The method of claim 9, further comprising:
identifying each available data link circuit based on hardware specifications for the computer system.

11. The method of claim 9, wherein determining the communication channel further comprising:
comparing the state determined for a first data link circuit of the one or more data link circuits to a threshold requirement, wherein the first data link circuit is the highest ranked data link circuit and the threshold requirement represents a measurable attribute for evaluating a potential communication channel involving the data link circuit; and
determining, responsive to the state of the highest ranked data link circuit satisfying the threshold requirement, the communication channel by selection of the first data link circuit at the computer system.

12. The method of claim 11, further comprising:
ranking each data link circuit of the computer system based on a predicted performance of a potential communication channel involving the data link circuit given the state determined for the data link circuit.

13. The method of claim 11, further comprising:
comparing, responsive to determining that the state of the highest ranked data link circuit does not satisfy the threshold requirement, the state determined for a second data link circuit of the one or more data link circuits to the threshold requirement, the second data link circuit being a next highest ranked data link circuit; and
determining, responsive to the state of the second highest ranked data link circuit satisfying the threshold requirement, the communication channel by selecting the second data link circuit at the computer system.

14. The method of claim 11, wherein the threshold requirement requires one of:
a signal strength measurement for the authentication device exceeding a threshold;
a packet loss rate measurement for the authentication device exceeding a threshold;
a channel occupancy rate measurement for the potential communication channel within a threshold for reliable data transmission; and
a latency measurement for the authentication device exceeding a threshold.

15. The method of claim 9, further comprising:
receiving, by the communication channel, a characterization for a data link circuit at the computer system and a characterization of a corresponding data link circuit at the authentication device, wherein the characterizations describe measurements of signals transmitted by the data link circuit and the corresponding data link circuit; and
determining a similarity between the characterization of the data link circuit at the computer system and the characterization of the corresponding data link circuit at the authentication device; and
determining, responsive to the similarity satisfying a threshold similarity, a proximity channel between the computer system and the authentication device by selecting the data link circuit at the computer system and the corresponding data link circuit at the authentication device.

16. The method of claim 15, further comprising:
comparing a state of the data link circuit at the computer system to a threshold requirement, wherein the threshold requirement represents a measurable attribute for evaluating a proximity communication channel involving the data link circuit; and
determining, responsive to the state of the data link circuit satisfying the threshold requirement, the proximity channel by selecting the data link circuit at the computer system and the corresponding data link circuit at the authentication device.

17. A non-transitory computer-readable storage medium, comprising stored instructions encoded thereon that, when executed by at least one processor, causes the processor to:
transmit, by a communication channel, an authentication request to an authentication device from a computer system, wherein the authentication request generated by a target user requesting access to a computer system and the communication channel transmits signals between the computer system and the authentication device; and
responsive to receiving validation of the authentication request from the authentication device, measure a proximity of the authentication device to the computer system based on data transmitted through a proximity channel; and
grant the target user access to the to the computer system responsive to the measured proximity of the authentication device satisfying a threshold proximity.

18. The non-transitory computer-readable storage medium of claim 17, wherein the instructions to determine the communication channel further comprises stored instructions that when executed cause the processor to:
compare a state determined for a data link circuit of the computer system to a threshold requirement, the threshold requirement representing a measurable attribute for evaluating a potential communication channel involving the data link circuit; and
select the data link in response to the state of the data link circuit satisfying the threshold requirement.

19. The non-transitory computer readable storage medium of claim 17, wherein instructions further cause the processor to:
receive, by the communication channel, a characterization for a data link circuit at the computer system and a characterization of a corresponding data link circuit at the authentication device, wherein the characterizations describe measurements of signals transmitted by the data link circuit and the corresponding data link circuit; and
determine a similarity between the characterization of the data link circuit at the computer system and the characterization of the corresponding data link circuit at the authentication device; and
determine, responsive to the similarity satisfying a threshold similarity, a proximity channel between the computer system and the authentication device by selection of the data link circuit at the computer system and the corresponding data link circuit at the authentication device.

20. The non-transitory computer readable storage medium of claim 19, further comprising instructions that cause the processor to:
compare a state of the data link circuit at the computer system to a threshold requirement, wherein the threshold requirement represents a measurable attribute for evaluating a proximity channel involving the data link circuit; and
determine, responsive to the state of the data link circuit satisfying the threshold requirement, the proximity channel by selection of the data link circuit at the computer system and the corresponding data link circuit at the authentication device.
